(19) United States
(12) Patent Application Publication
(10) Pub. No.: US 2019/0152621 A1
(43) Pub. Date: May 23, 2019

(54) MANUFACTURING AND ASSEMBLY METHOD AND SYSTEM OF PARTS OF AN AIRCRAFT

(71) Applicant: Airbus Defence and Space SAU, Getafe (ES)

(72) Inventors: Fernando ESTEBAN FINCK, Getafe (ES); Francisco Javier JIMÉNEZ DURÁN, Getafe (ES); Francisco José LEÓN ARÉVALO, Getafe (ES); Francisco RODRÍGUEZ GARRIGÓS, Getafe (ES); Luis GRANERO MONTAGUD, Getafe (ES)

(21) Appl. No.: 16/192,964

(22) Filed: Nov. 16, 2018

(30) Foreign Application Priority Data
Nov. 17, 2017 (ES) 201731337

(51) Int. Cl. B64F 5/10; G06F 17/50; G06T 17/00

(52) U.S. Cl. CPC B64F 5/10; G06T 17/00; G06F 17/5086

(57) ABSTRACT

A manufacturing and assembly method of parts of an aircraft comprising the following several steps. Providing a first aircraft part comprising a receptor surface on which a coupling surface of a second aircraft part is to be assembled. Providing a model of the first and the second aircraft parts in their assembled position, the model of the second aircraft part comprising machining allowances in its coupling surface. Digitalizing the receptor surface of the first aircraft part. Positioning the digitalization in the computer model in the assembled position such that the digitalization of the receptor surface intersects the coupling surface of the second aircraft part. Obtaining a model of the second part in which the coupling surface fits the digitalized receptor surface. Mechanizing the second aircraft part.

### CROSS-REFERENCES TO RELATED APPLICATIONS

This application claims the benefit of the Spanish patent application No. 201731337 filed on Nov. 17, 2017, the entire disclosures of which are incorporated herein by way of reference.

### FIELD OF THE INVENTION

The present invention relates to a manufacturing and assembly method and system of parts of an aircraft with fast manufacturing and reducing the need of jigs for performing the manufacturing and assembly operations.

### BACKGROUND OF THE INVENTION

In the aeronautic industry, the assembly of parts in big structures with small tolerances is very common, for instance, it is performed in spinning axes in horizontal stabilizers, wings or fuselages.

Currently, in order to assemble these parts, jigs or tooling with big stable welded structures are used, mounted and assembled with an exterior verification system, as a laser tracker, micro-alignment telescopes, transit or theodolites. In some cases, photogrammetry, articulated arms, laser radars or portable optic measurement systems are used. On these structures, the part to be assembled is positioned in the required position.

These jigs require foundations with strong requirements in order to avoid undesired movements of the metallic structure of the jig and constant verifications to ensure that the structure has not moved from its initial state. In general, the positioning of aircraft parts is carried out with tooling auxiliary parts attached to the jigs and positioned with an external positioning system, for instance, fittings attached to the jig that position aircraft axes in the appropriate position.

All these resources needed for the manufacturing correspond to 10% of the global cost of an aeronautical structure. The costs are divided into Non-Recurrent Costs (NRC), the initial investment, and Recurrent Costs (RC). Jigs and tooling costs are mainly a part of the NRC.

Estimations show that more than a third of the NRC of an aircraft manufacturing is due to jigs and tooling. This fact represents an enormous capital investment, with long return periods.

More problems associated with the use of big structures with “hard points” of reference or, what is the same, points that require periodic verification are:

Jigs are specifically manufactured for a specific program and without the possibility of being reused in another program. When a program finishes it is impossible to reuse the jig as it is not possible to adapt it to a new program.

Jigs need recalibration in order to ensure its exactness. This periodical operation (usually once or twice a year) is expensive, complicated and require long periods of inactivity.

The difference between aircraft and jig materials create problems regarding assembly and measurement due to thermal dilatations.

### SUMMARY OF THE INVENTION

A manufacturing and assembly method and system object of the invention modifies the traditional assembly processes. Due to new measurement, design and manufacturing processes, the assembly of parts can be done with great precision without conventional jigs, reducing design, manufacturing, assembly and maintenance costs. The avoidance of a necessity for conventional jigs implies not only time and cost savings in the design, manufacturing and maintenance of the parts, but also the disappearance of the lack of flexibility of traditional methods.

A manufacturing and assembly method object of the invention comprises the following steps:

providing a first aircraft part comprising at least a receptor surface on which a coupling surface of a second aircraft part is to be assembled,

providing, in a computer program, a model of the first and the second aircraft parts located in their assembled position, the model of the second aircraft part comprising machining allowances in its coupling surface,

digitalizing, by a digitalizing system, the receptor surface of the first aircraft part obtaining a digitalized surface, for instance, formed by a cloud of points,

positioning the digitalization of the receptor surface in the computer model of the first and the second aircraft parts in the assembled position such that the digitalization of the receptor surface intersects the machining allowances of the coupling surface of the second aircraft part,

obtaining, in the computer model, a computer designed model of the second aircraft part in which the coupling surface of the second aircraft part adapted to be assembled on the receptor surface of the first aircraft part fits to the digitalized receptor surface,

mechanizing the second aircraft part to be assembled from the above obtained computer model,

assembling the mechanized second aircraft part to the provided first aircraft part.

Therefore, the key steps of the claimed manufacturing and assembly method are: starting with a receptor surface that may be located in an unknown position, digitizing the receptor surface, positioning the digitalization in a computer designed theoretical model of the first and the second aircraft parts, for instance a CAD model, in its real assembled position wherein the coupling surface of the second aircraft part comprises machining allowances, i.e., it is oversized with respect to its nominal size. The digitalization of the receptor surface therefore intersects the machining allowances of the coupling surface of the second aircraft part and the coupling surface of the second aircraft part is achieved by obtaining a surface that fits the cloud of points, i.e., the digitized receptor surface in the computer theoretical model. For instance, with reverse engineering it will be obtained a CAD reconstruction of the real part of the second aircraft part which adapts to the receptor surface.

The obtained CAD model of the second aircraft part comprises, therefore, a coupling surface that is a copy of the receptor surface of the first part and thus implying that the adjustment between both elements may have minimal deviations. The advantage avoids the need to employ liquids or solids applications between both surfaces in the assembly process. The tailored manufacturing of the second aircraft part allows its perfect adjustment with the receptor surface of the first aircraft part fulfilling the established tolerances. This, in turn, involves the removal of a shim element, both solid and liquid, at the interfaces of both parts. The CAD model will be afterwards exported to a proper format for mechanization of the second aircraft part.

The first aircraft part may be positioned in a stable element, with a known position not being necessary. The main advantage over the known methods is that the element where the first and second parts are to be placed does not require precise positioning in a conventional jig. This jig element could be replaced, due to the claimed invention, by a support structure of smaller mechanical restrictions involving cost reduction, maintenance, etc., in the embodiments in which the support structure is advisable.

Therefore, the claimed method comprises a set of operations and measurements that will provide as a result the manufacturing, positioning and assembly of a part, for instance, fitting, axis...in its assembly position meeting tolerance requirements.

It is also an object of the invention a manufacturing and assembly system comprising:

a computer program model of a first and a second aircraft part configured to be located in their assembled positions, the first aircraft part configured to have at least a receptor surface on which a coupling surface of the second aircraft part is to be assembled and the model of the second aircraft part comprising machining allowances in its coupling surface,

a digitalizing system configured to digitalize the receptor surface of the first aircraft part, for instance, obtaining a cloud of points,

the computer program model being configured to position the digitalization of the receptor surface in the assembled position such that the digitalization of the receptor surface intersects the machining allowances of the coupling surface of the second aircraft part,

the computer program model being also configured to obtain a computer designed model of the second aircraft part in which the coupling surface of the second aircraft part adapted to be assembled on the receptor surface of the first aircraft part is configured to fit the digitalized receptor surface,

a mechanizing system configured to mechanize the obtained computer designed model of the second aircraft part.

Summarizing, the claimed system and method provides the following advantages:
Reduction of costs in jigs.
Reduction of manufacturing times.
Elimination or drastic reduction of the use of shims, either liquids or solids.
Reduction of maintenance of jigs.
Custom manufacture of components with detailed analysis of each one and dimensional traceability.

### BRIEF DESCRIPTION OF THE DRAWINGS

To complete the description and in order to provide for a better understanding of the invention, a set of drawings is provided. The drawings form an integral part of the description and illustrate preferred embodiments of the invention. The drawings comprise the following figures.

FIG. 1 shows a perspective view of an embodiment of an assembled first and a second aircraft structure, being the first aircraft structure mounted on a support structure.

FIG. 2 shows a perspective view of the intersection of a digitized receptor surface of the first aircraft structure and a CAD model of the second aircraft structure.

FIG. 3 shows a perspective view of the CAD model of the second aircraft structure having a coupling surface obtained from the receptor surface.

### DETAILED DESCRIPTION OF THE PREFERRED EMBODIMENTS

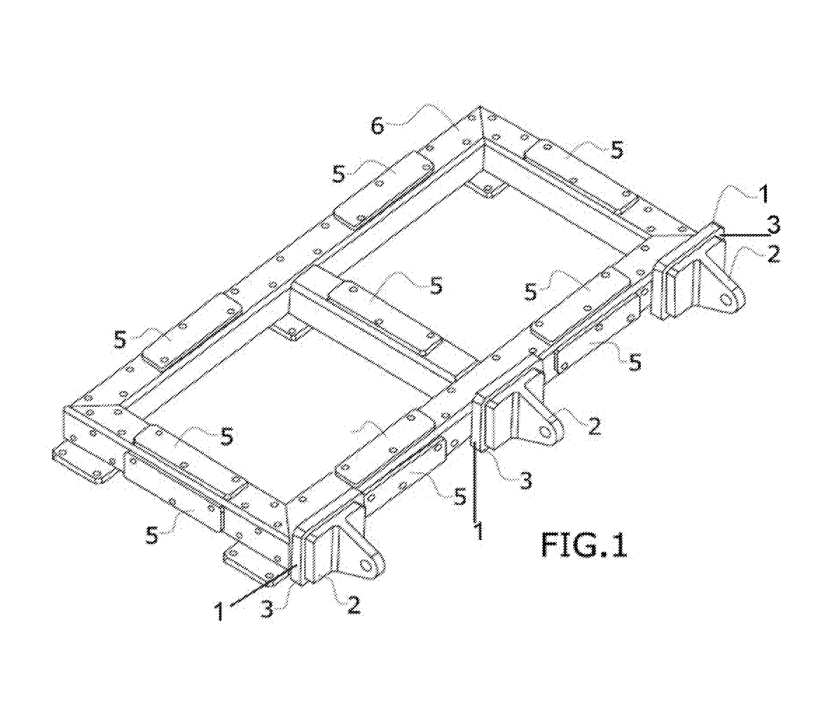

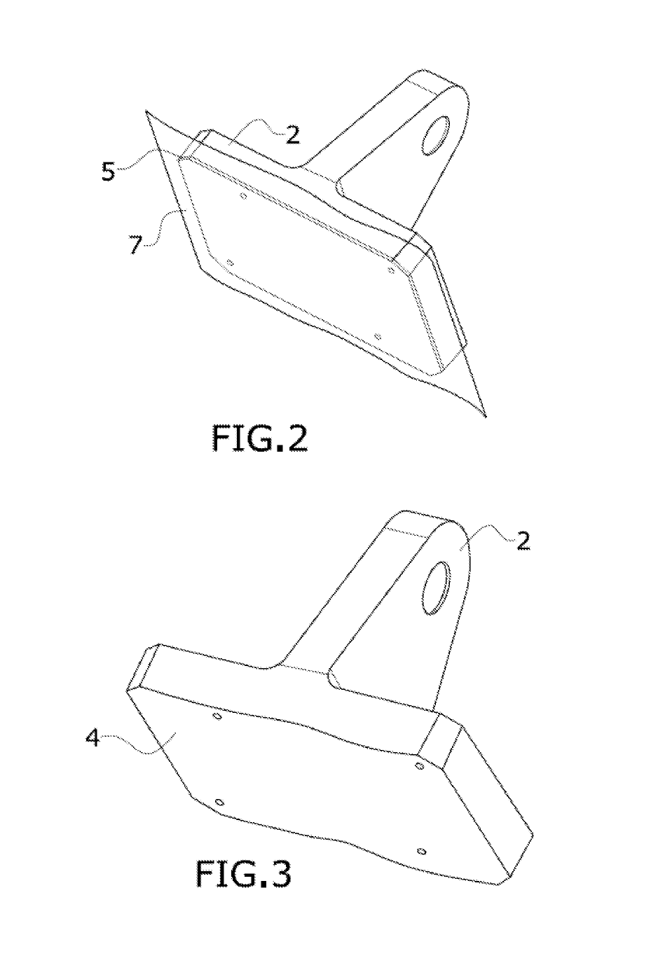

FIG. 1 discloses an embodiment showing a first aircraft part (1) coupled to a support structure (6) comprising a set of reference elements (5), specifically a set of reference surfaces, and three receptor surfaces (3) of three second aircraft parts (2), specifically, three fittings adapted to be joined to the three receptor surfaces (3).

The reference elements (5) will be used to properly align the digitized receptor surface (3) with the computer designed model (CAD) of the first (1) and the second (2) aircraft parts. Therefore, the set of reference elements (5) collaborates in the proper alignment of the cloud of points with the CAD model. Another possibility, although less preferred, is to locate the reference elements (5) directly on the first aircraft part (1). The advantage of locating the reference elements (5) on a support structure (6) of the first aircraft part (1) is that the aircraft part (1) does not need to be manipulated to locate or to remove the reference elements (5) and secondly that the same support structure (6) with its reference elements (5) can be used for the assembly of several aircraft parts (1, 2) of the same kind.

Therefore, a support structure (6) comprising the reference elements (5) would be advisable, i.e., an external support structure (6) that will be used to locate the reference elements (5). This support structure (6) requires some dimensional stability but not as restrictive as in the case of the jigs.

Thus, in an embodiment, the method comprises the following steps:

providing a set of reference elements (5) coupled with the first aircraft part (1),

providing a computer model of the first (1) and the second (2) aircraft parts comprising the set of reference elements (5),

digitalizing by a digitalizing system the set of reference elements (5),

aligning the digitalized reference elements (5) with the computer model of the first (1) and the second (2) aircraft parts.

Once the reference elements (5) are established and digitized, the next step is to generate a cloud of points that will serve as the basis for the subsequent obtaining of the desired surfaces. In this digitalization, information has been obtained from both the receptor surface (3) and the set of reference elements (5) that could be used for the alignment.

As previously stated, once the results of the digitalizing process are obtained, they must be aligned with the CAD model. The correctness of this alignment process is important for achieving an accurate result, and requires the proper choice of alignment reference elements (5). In this sense, it is advisable that the reference elements (5) used in the alignment process is distributed evenly throughout the first aircraft structure (1) or throughout the support structure (6), whichever is the case.

Once the cloud of points obtained in the digitalization process has been processed, the cloud of points will be exported in the appropriate format, for instance, .asc, to the chosen modeling software, i.e., CATIA. It is important to point out at this point a set of considerations that is advisable to be taken into account:

1. The more uniform the distribution of the points generated in the cloud of points, the better is the generated surface.

2. Having previously aligned all elements of the set measured, the situation of these with respect to the CAD model will be correct.

Once the cloud of points is available, the next step would be, optionally, setting the parameters for creating a mathematical function (7) of the receptor surface (3), therefore a mathematical function (7) is extracted from the cloud of points of the receptor surface (3) using software.

With a mathematical function (7) of the receptor surface (3) generated from the cloud of points, and given that it has the appropriate location to intersect the theoretical CAD model of the second aircraft part (2), the final model of the second aircraft part (2) for manufacturing will be generated. Thus, a simple trimming operation will allow us to obtain the desired morphology with respect to the theoretical fitting of the embodiment.

As previously stated, the CAD model of the second aircraft part (2) comprises machining allowances for its subsequent machining and adjustment on the receptor surface (3). It is important to keep in mind that as the fittings to be positioned comprise machining allowances, interferences will appear between the receptor surfaces and the fittings. These interferences will be used for subsequently cutting the length of the fittings.

Additionally, in an embodiment, to digitize the whole first aircraft part (1) a plurality of digitalization steps are to be performed, thus the first aircraft part (1) being digitized in sections that are afterwards aligned. For instance, shadows may be created because of the shape of the first aircraft part (1) that make it necessary to digitize the part (1) from different points of view or the first aircraft part (1) may be too large to be digitalized in only one step.

In order to properly align the different digitalization sections to form the whole first aircraft part (1), alignment targets are located on the support structure (6) or on the first aircraft part (1). As previously explained for the reference elements (5) it is preferred to locate the target elements on the support structure (6) for the same reasons stated above.

In an embodiment, the alignment targets are small stickers that are located on the surface of the support structure (6). Using optical methods, like photogrammetry, the relative position of the alignment targets can be obtained with high accuracy, the alignment targets defining a photogrammetric skeleton of the support structure (6). The positions will be used to assembly the different clouds of points obtained in the digitalization process. The photogrammetry skeleton is simply used to refer or overlap the different shots that are made of the aeronautical element, and above all to reduce measurement errors.

Using a high resolution digitalization system, the receptor surface (3) will be digitized, automatically aligning the digitized surface (3) with the photogrammetry skeleton of the support structure (6) due to target recognition. Therefore, the following steps are performed:

providing a set of alignment targets coupled with the first aircraft part (1),

defining a photogrammetric skeleton of the alignment targets coupled to the first aircraft part (1),

providing a computer model of the first (1) and the second (2) aircraft parts comprising the set of alignment targets,

digitalizing by a digitalizing system the set of alignment targets,

aligning the photogrammetry skeleton with the program model of the first aircraft part (1),

digitalizing the receptor surface (3).

More specifically in an embodiment, the following steps are performed:

Placing a set of target elements, for instance, stickers, in different sections of the support structure (6) of the first aircraft part (1) that will serve as reference points of the different shots to perform.

Produce a photogrammetry skeleton from the set of target elements.

Aligning the photogrammetry skeleton comprising the target elements with the CAD model of the first aircraft part (1),

Digitalizing the receptor zones (3) by means of the high resolution digitalization system.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A manufacturing and assembly method of parts of an aircraft comprising the following steps:
providing a first aircraft part comprising at least a receptor surface on which a coupling surface of a second aircraft part is to be assembled,
providing, in a computer program, a computer model of the first and the second aircraft parts located in their assembled position, the model of the second aircraft part comprising machining allowances in its coupling surface,
digitalizing, by a digitalizing system, the receptor surface of the first aircraft part obtaining a digitalization of the receptor surface,
positioning the digitalization of the receptor surface in the computer model of the first and the second aircraft parts in the assembled position such that the digitalization of the receptor surface intersects the machining allowances of the coupling surface of the second aircraft part,
obtaining, in the computer model, a computer designed model of the second part in which the coupling surface of the second aircraft part configured to be assembled on the receptor surface of the first aircraft part fits to the digitalization of the receptor surface,
mechanizing the second aircraft part to be assembled from the above obtained computer model,
assembling the mechanized second aircraft part to the provided first aircraft part.

2. The manufacturing and assembly method of parts of an aircraft, according to claim 1, further comprising the following steps:
providing a set of reference elements coupled with the first aircraft part,
providing a computer model of the first and the second aircraft parts comprising said set of reference elements,
digitalizing, by a digitalizing system, the set of reference elements to obtain digitalized reference elements,
aligning the digitalized reference elements with the computer model of the first and the second aircraft parts.

3. The manufacturing and assembly method of parts of an aircraft, according to claim 2, further comprising a step of providing the first aircraft part over a supporting structure, said supporting structure comprising the set of reference elements.

4. The manufacturing and assembly method of parts of an aircraft, according to claim 1, wherein the digitalized surface of the receptor surface of the first aircraft part is formed by a cloud of points and the method further comprises a step of obtaining a mathematical function from the cloud of points by a computerized processing system.

5. The manufacturing and assembly method of parts of an aircraft, according to claim 1, further comprising a digitalization of an entire surface of the first aircraft part which is performed in steps of different sections of the first aircraft part that are afterwards aligned.

6. The manufacturing and assembly method of parts of an aircraft, according to claim 5, comprising the following steps:
providing a set of alignment targets coupled with the first aircraft part,
defining a photogrammetric skeleton of the set of alignment targets coupled to the first aircraft part,
providing a computer program model of the first and the second aircraft parts comprising said set of alignment targets,
digitalizing, by a digitalizing system, the set of alignment targets,
aligning the photogrammetry skeleton with the computer program model of the first aircraft part,
digitalizing the receptor surface.

7. A manufacturing and assembly system of parts of an aircraft, comprising:
a computer program model of the first and the second aircraft parts configured to be located in their assembled positions, the first aircraft part configured to have at least a receptor surface on which a coupling surface of the second aircraft part is to be assembled and the computer program model of the second aircraft part comprising machining allowances in a coupling surface of the second aircraft part,
a digitalizing system configured to digitalize the receptor surface of the first aircraft part to obtain a digitalization of the receptor surface,
the computer program model being configured to position the digitalization of the receptor surface in the assembled position such that the digitalization of the receptor surface intersects the machining allowances of the coupling surface of the second aircraft part,
the computer program model being also configured to obtain a computer designed model of the second part in which the coupling surface of the second part configured to be assembled on the receptor surface of the first part is configured to fit the digitalization of the receptor surface,
a mechanizing system configured to mechanize the obtained computer designed model of the second part.

8. The manufacturing and assembly system of parts of an aircraft, according to claim 7, including a set of reference elements coupled with the first aircraft part which are digitalized, wherein the computer program model of the first and the second aircraft parts comprise an alignment of the digitalized reference elements with the computer model of the first and the second aircraft parts.

9. The manufacturing and assembly system of parts of an aircraft, according to claim 8, further comprising a supporting structure of the first aircraft part, said supporting structure comprising the reference elements.

10. The manufacturing and assembly system of parts of an aircraft, according to claim 7, wherein the digitalizing system is configured to obtain a cloud of points of the digitalization of the receptor surface of the first aircraft part and the manufacturing and assembly system comprises a processing system configured to define a mathematical function for the receptor surface from the cloud of points and to obtain a computer designed model of the second part in which the surface of the second part adapted to be assembled on the receptor surface of the first aircraft part adapts to the mathematical function for the receptor surface.

11. The manufacturing and assembly system of parts of an aircraft, according to claim 7, further comprising:
a set of alignment targets coupled with the first aircraft part,
a photogrammetry system configured to digitalize the alignment targets and to define a photogrammetric skeleton of said alignment targets,
the computer program model of the first and the second aircraft parts comprising said set of alignment targets,
the digitalizing system configured to digitalize the set of alignment targets,
the computer program model being configured to the photogrammetry skeleton with the computer program model of the first aircraft part.
